(19) United States
(12) Patent Application Publication
(10) Pub. No.: US 2011/0090317 A1
(43) Pub. Date: Apr. 21, 2011

(54) STEREOVISION SYSTEM AND METHOD FOR CALCUALTING DISTANCE BETWEEN OBJECT AND DIFFRACTIVE OPTICAL ELEMENT

(75) Inventors: Shyh-Haur Su, Zhubei City (TW); Chih-Cheng Cheng, Banqiao City (TW); Jwu-Sheng Hu, Hsinchu City (TW); Shyh-Roei Wang, Hsinchu City (TW); Yu-Nan Pao, Zhubei City (TW); Chin-Ju Hsu, Tainan City (TW)

(73) Assignee: INDUSTRIAL TECHNOLOGY RESEARCH INSTITUTE, Hsin-Chu (TW)

(21) Appl. No.: 12/788,496

(22) Filed: May 27, 2010

(30) Foreign Application Priority Data
Oct. 20, 2009 (TW) 098135356

(51) Int. Cl. H04N 13/02; G01B 11/14

(52) U.S. Cl. 348/49; 356/625; 348/E13.074

(57) ABSTRACT

A stereovision system is disclosed, which comprises: at least one diffractive optical element and an optical imaging device. Each of the diffractive optical element is used for allowing a first beam containing information relating to an object to pass through and thus transforming the same into a second beam containing information relating to the object. The optical imaging device is used for receiving the second beam so as to concentrate the energy thereof for forming an M^{th}-order diffraction image. By combining the aforesaid M^{th}-order diffraction image with another energy-concentrated N^{th}-order diffraction image, a series of images can be formed. Accordingly, by comparing the disparity between corresponding points in the series of images, the distance between the object and the diffractive optical element can be obtained. It is noted that the aforesaid M and N represent the order of diffraction.

### TECHNICAL FIELD

The present disclosure relates to a stereovision system and method for calculating distance between object and diffractive optical element used in the system, and more particularly, to a compact stereovision system with comparatively simpler framework that is adapted to perform well under common ambient lighting condition without requiring illumination from any active light source.

### TECHNICAL BACKGROUND

With rapid advance of computer stereovision system, it is not only being used commonly in mobile robots for dealing with finding a part and orienting it for robotic handling or for obstacle detection, but also can be used in many human-machine interfaces such as in a vehicular vision system for enhancing driving safety. As for the range finding means that are currently used in the computer stereovision system, they can be divided and classified as the visual method and non-visual method, in which the visual method includes structural light analysis algorithm, disparity analysis algorithm, TOF (time of flight) principle and defocus-focus analysis algorithm, whereas the non-visual method includes acoustic wave detection, infrared detection, laser detection, and so on.

It is noted that the performing of the visual method usually relies on the use of an optical imaging device for capturing images of a target at different focal distances so as to determine a range to the target based thereon, which can be a very slow process just to determine the range, not to mention that the optical imaging device can be very complex and bulky.

It is mots often that 3D stereo vision is achieved by the extraction of 3D information from images captured by the use of TLR (twin lens reflex) cameras. On the other hand, two cameras, displaced horizontally from one another are used to obtain images of differing views on the same scene, can also be used for achieving 3D stereo vision. Operationally, a computer is used for comparing the images while shifting the two images together over top of each other to find the parts that match, whereas the matching parts are referring as the corresponding points and the shifted amount is called the disparity. Accordingly, the disparity at which objects in the image best match and the featuring parameters of the cameras are used by the computer to calculate their distance. Nevertheless, for the images from TLR cameras, the core problem for achieving 3D stereo vision is to acquire the corresponding points from the captured images accurately and rapidly. For the two-camera system, the trade-off between the size of the system and the depth resolution of the system can achieve is the main concern for designing the system since the larger the base-line is designed between the two cameras, the smaller the depth resolution of the system can achieve. In addition, the working area of the two-camera system is restricted to the intersection of the field-of-views of the two cameras. Therefore, the performance of the two-camera system is greatly restricted since it can not detect any thing that is too close or too far away from the system. There are already many studies for achieving 3D stereo vision. One of which is a vision system adapted for vehicle, disclosed in U.S. Pat. No. 7,263,209, entitled “Vehicular vision system”. The aforesaid vision system is capable of identifying and classifying objects located proximate a vehicle from images of differing views on the same scene that are captured by two cameras, in a manner similar to human binocular vision, so as to generate depth maps (or depth images) of the scene proximate a vehicle. It is noted that the vehicular vision system is primarily provided for providing target detection to facilitate collision avoidance.

In U.S. Pat. No. 4,678,324, entitled “Range finding by diffraction”, a method and system are provided for determining range by correlating the relationship between the distance of a diffraction grating from a monochromatically illuminated target surface with the respective relative displacements of higher order diffraction images from the position of the zero order image as observed through the diffraction grating. In U.S. Pat. No. 6,490,028, entitled “Variable pitch grating for diffraction range finding system”, a diffraction grating with variations in pitch is provided, such that the displacement of higher-order diffraction images in a receiver are separated from their associated zero-order image while enabling the so-generated higher-order displacements in a diffraction range finder to vary linearly as function of target distance. In U.S. Pat. No. 6,603,561, entitled “Chromatic diffraction range finder”, a method and system are provided for determining range by correlating a relationship between one or more distances of a diffraction grating from an illuminated target surface with variations in the respective wavelengths of high order diffraction spectra, whereas the high order diffraction spectra are observed through the diffraction grating and the high order diffraction spectra are derived from broadband radiation transmitted from the illuminated target surface. However, all the three abovementioned systems require their observed objects to be illuminated by active light sources, otherwise, the optical detection disclosed in the aforesaid disclosures can not be performed. Thus, the arrangement of the active light source is going to cost the systems of the aforesaid disclosures to pay a price in terms of structural complexity, high manufacture cost and large size.

### TECHNICAL SUMMARY

The present disclosure provides a stereovision system and method for calculating distance between object and diffractive optical element used in the system, that is a compact stereovision system with comparatively simpler framework and is adapted to perform well under common ambient lighting condition without requiring illumination from any active light source. Nevertheless, the stereovision system of the present disclosure is capable of cooperating with an active light source that is designed to produce light of a specific wavelength range, by that, with the help of specialized filters, the adverse affect of light and shadow resulting from ambient lighting can be overcome so as to enhance the target images.

To achieve the above object, the present disclosure provides a stereovision system and method for calculating distance between object and diffractive optical element used in the system, in which the stereovision comprises: at least one diffractive optical element and an optical imaging device. Each of the diffractive optical element is used for allowing a first beam containing information relating to an object to pass through and thus transforming the same into a second beam containing information relating to an object. The optical imaging device is used for receiving the second beam so as to concentrate the energy thereof for forming an M^{th}-order diffraction image. By combining the aforesaid M^{th}-order diffraction image with another energy-concentrated N^{th}-order diffraction image, a series of images can be formed. Accordingly, by comparing the disparity between corresponding points in the series of images, the distance between the object and the diffractive optical element can be obtained. It is noted that the aforesaid M and N represent the order of diffraction.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram showing a stereovision system according to an embodiment of the present disclosure.

FIG. 2 is a schematic diagram showing the diffraction of a grating.

FIG. 3 is a schematic diagram showing a blazed grating.

FIG. 4 is a chart showing the relation of the transmission of −1 order diffraction and correlated parameters of a blazed grating when a visible light of 0.5 μm in wavelength is used in the stereovision system of the present disclosure.

FIG. 5 is a chart showing the relation of the transmission of −2 order diffraction and correlated parameters of a blazed grating when a visible light of 0.5 μm in wavelength is used in the stereovision system of the present disclosure.

FIG. 6 is a chart showing the relation of the transmission of −1 order diffraction and correlated parameters of a blazed grating when a visible light of 0.85 μm in wavelength is used in the stereovision system of the present disclosure.

FIG. 7 is a chart showing the relation of the transmission of −2 order diffraction and correlated parameters of a blazed grating when a visible light of 0.85 μm in wavelength is used in the stereovision system of the present disclosure.

FIG. 8 shows the relation between offset and target distance in the stereovision system of the present disclosure.

FIG. 9 is a schematic diagram showing how a blazed grating and an image sensing array are orientated with respect to each other in the stereovision system of the present disclosure.

FIG. 10 is a schematic diagram showing how diffraction images resulting from the used of system of FIG. 9 are used for constructing a 3D stereovision.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

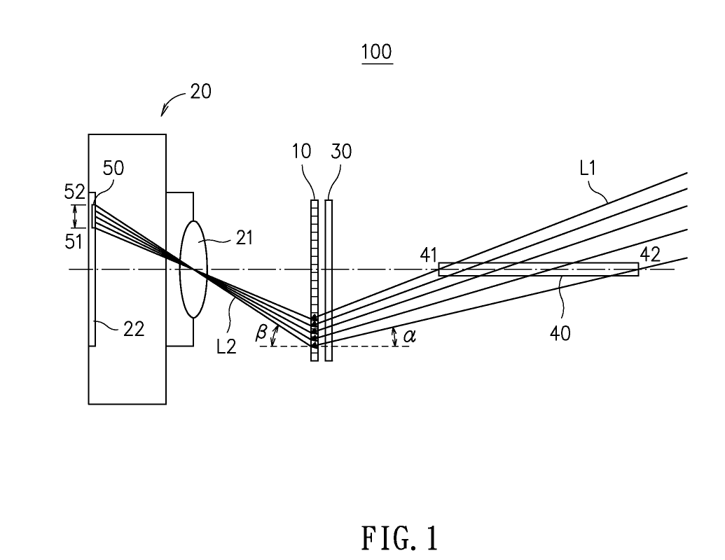

Please refer to FIG. 1, which is a schematic diagram showing a stereovision system according to an embodiment of the present disclosure. In FIG. 1, a stereovision system 100 is disclosed, which is comprised of: a diffractive optical element 10 and an optical imaging device 20. The diffractive optical element 10 can be a transmission blazed grating as it is characterized in that: it can change the traveling direction of an incident light for concentrating energy to a specific order of diffraction and thus enhance the image resulting from that order of diffraction while simultaneously enabling the other orders of diffraction with lower energy concentration to form images. As shown in FIG. 1, a first beam L1 is provided for projecting the same toward the diffractive optical element 10 and traveling passing the same to be converted into a second beam L2, which is directed toward the optical imaging device 20. Moreover, there is a filter 30 disposed on the optical path of the first beam L1 as it is projecting toward the diffractive optical element 10 in a manner that the first beam L1 is projected passing through the filter 30 and thus traveling toward the diffractive optical element 10, and the optical imaging device 20 is further comprised of: an image sensor 22, for receiving the second beam L2 and thus forming an image accordingly; and a lens 21, disposed on the optical path of the second beam L2 as it is projecting toward the image sensor 22 in a manner that the second beam L2 is projected passing through the lens 21 and thus traveling toward the image sensor 22 for forming the image therein. It is noted that the image sensor 22 can be a charge-coupled device (CCD) or a complementary metal-oxide semiconductor (CMOS).

Since the diffractive optical element 10 used in the present disclosure is substantially a transmission blazed grating, the diffraction angles for each order of diffraction of different wavelengths can be induced under equal optical path difference condition according to the following grating equation:

d(sin α±sin β)=mλ (1)

wherein α: the angle between the incident light and the normal to the grating (the incident angle)
β: the angle between the diffracted light and the normal to the grating (the diffraction angle)
d: spacing between the slits (the grating period)
m: order of diffraction (m=0, ±1, ±2, . . . )
λ: wavelength

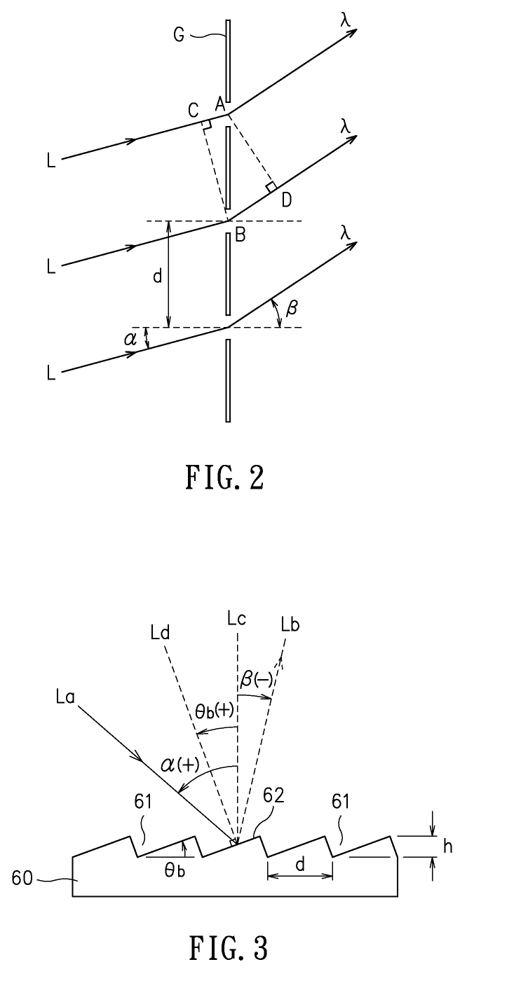

As shown in FIG. 2, when the optical path difference between the path representing by the line B̅D̅ and the path representing by the line C̅A̅ is an integer multiple of the wavelength λ as the resulting of the light L travelling passing the grating G, there will be constructive interference that fulfills the aforesaid grating equation.

As diffractive optical element is usually being used for light splitting or for changing the light traveling direction, the diffraction efficiency is an important operation factor as it is a value that expresses the extent to which energy can be obtained from diffracted light with respect to the energy of the incident light. A blazed grating is a special type of diffraction grating that can have good diffraction efficiency and good light-splitting effect. In a blazed grating, by the adjusting of the relative angle between an incident light and its grating facet, the diffracted light is directed to travel at a direction the same as the light being reflected by the facet. As shown in FIG. 3, a blazed grating 60 is formed with grooves 61 that have a sawtooth profile. Each groove 61 is comprised of a facet 62, whereas each facet 62 can be substantially a micro mirror for concentrating most of the energy into a specific higher-ordered diffracted light. In FIG. 3, light La is directed at a facet 62 at angle α and light of wavelength λ is diffracted into diffracted light Lb at angle β. Here, α and β are the angles made with the normal to the grating and counterclockwise direction is taken as positive. Moreover, d represents the spacing between the slits, i.e. the grating period. When the relationship between the incident light and the M^{th}-order diffracted light describes mirror reflection with respect to the facet surface of the grooves, most of the energy is concentrated into the M^{th}-order diffracted light and thus the facet angle of the grooves at this point is called the blaze angle, and, represented by θ_{B}, satisfies the following:

α−θ_{b}=θ_{b}−β or θ_{b}=(α+β)/2 (2)

Combining equations (1) and (2) gives the following:

d(sin α−sin(α−2θ_{b}))=mλ (3)

According to the aforesaid equation (3), a blazed grating of a specific blazed angle can be designed for a light of specific blazed wavelength, as the diffractive optical element 10 used in the present disclosure shown in FIG. 1. As shown in FIG. 3, the blazed grating is able to concentrate most of the energy for beams of different wavelengths into a specific ordered diffracted light by adjusting its depth h and the grating period d.

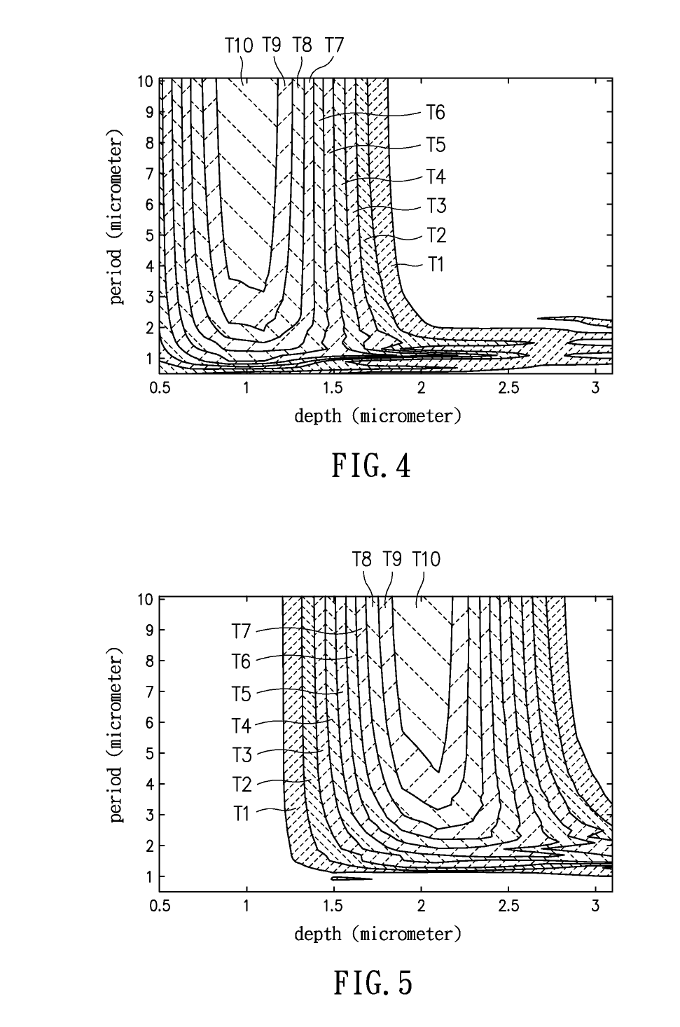

Please refer to FIG. 4 to FIG. 7, which are charts showing the relation of the different diffracted lights and correlated parameters of a blazed grating in depth and grating period when a visible light and an infrared light are used in the stereovision system of the present disclosure. Wherein, the areas T1˜T10 represent respectively the transmission of 0.1 to 0.8, that is, the transmission in the area T1 is 0.1, the transmission in the area T10 is 0.8, the transmissions in the area T3˜T5 are about 0.3˜0.4, and the transmissions in the area T6˜T8 are about 0.5˜0.6.

The light used in FIG. 4 and FIG. 5 is a visible light of 0.5 μm in wavelength, but the difference between those shown in FIG. 4 and FIG. 5 is that: FIG. 4 is a chart relating the transmission of −1 order diffraction while FIG. 5 is a chart relating to the transmission of −2 order diffraction. As shown in FIG. 4 and FIG. 5, when the transmission is required to achieve 0.8, i.e. in the area of T10, while concentrating energy into −1 order diffraction, the resulting grating should have a depth ranged between 0.8˜1.2 micrometers and a grating period ranged between 3˜10 micrometers, and on the other hand, while concentrating energy into −2 order diffraction, the resulting grating should have a depth ranged between 1.8˜2.2 micrometers and a grating period ranged between 4˜10 micrometers.

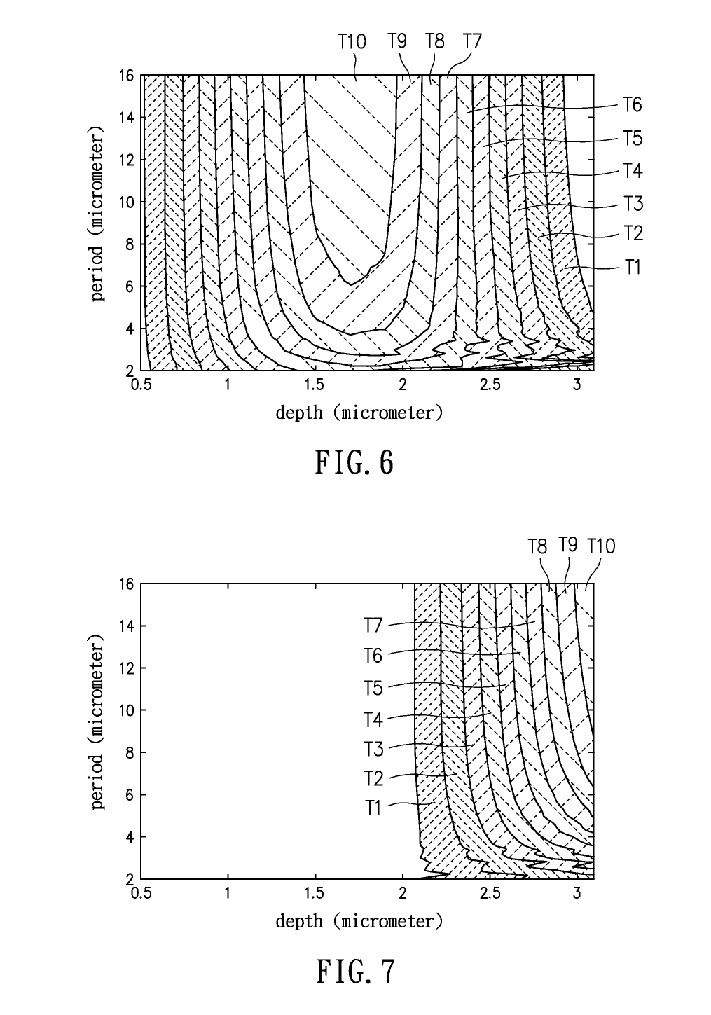

Nevertheless, light used in FIG. 6 and FIG. 7 is an infrared light of 0.85 μm in wavelength, but the difference between those shown in FIG. 6 and FIG. 7 is that: FIG. 6 is a chart relating the transmission of −1 order diffraction while FIG. 7 is a chart relating to the transmission of −2 order diffraction. As shown in FIG. 6 and FIG. 7, when the transmission is required to achieve 0.8, i.e. in the area of T10, while concentrating energy into −1 order diffraction, the resulting grating should have a depth ranged between 1.4˜1.95 micrometers and a grating period ranged between 6˜16 micrometers, and on the other hand, while concentrating energy into −2 order diffraction, the resulting grating should have a depth ranged between 3˜3.1 micrometers and a grating period ranged between 9˜16 micrometers.

According to FIG. 4 to FIG. 7, the blazed grating is able to concentrate most of the energy for beams of different wavelengths into a specific ordered diffracted light by adjusting its depth h and the grating period d, and thus enhance the image resulting from that order of diffraction. Therefore, the blazed grating can be adopted to be the diffractive optical element 10 used in the present disclosure, as the one shown in FIG. 1. It is noted that the first beam used in the present disclosure can be a visible light including ambient light, or an invisible light such as infrared light. Moreover, although the embodiments shown in FIG. 4 to FIG. 7 only illustrate −1 and −2 order diffractions, they are not limited thereby and thus can be applied to other higher order diffraction or zero order diffraction, which will not be described further hereinafter.

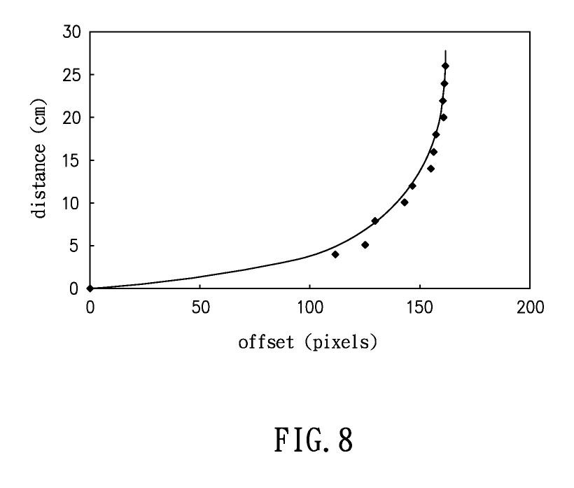

With reference to FIG. 1, the following description is provided for illustrating the imaging principle of the present disclosure. After the first beam L1, is projected on an object 40, the first beam L1 containing relating to the object 40 is projected to the filter 30 and the diffractive optical element 10 by an incident angle α. Thereafter, it is further projected out of the diffractive optical element 10 by a diffraction angle β while being converted into a second beam L2 which also contains information relating to the object 40. The second beam L2 is then being directed toward the optical imaging device 20, in which the second beam L2 will first enter the lens 21 and then into the image sensor 22 where it is used for formed a diffraction image 50 therein. As shown in FIG. 1, the object 40 is constructed with a first top 41 and a second top 42, and correspondingly that the diffraction image 50 has a first image end 51 and a second image end 52. By comparing and analyzing the relative positioning of the first top 41, the second top 42, the first image end 51 and the second image end 52, the imaging of the object 40 into the diffraction image 50 can be realized. As the diffraction image 50 is resulting from the diffraction of the diffractive optical element 10 working on the first beam L1, it can be an energy-concentrated M^{th}-order diffraction image, whereas the M, being used for indicating the order of diffraction, is not limited but is determined according to actual requirement. Nevertheless, there are other diffraction images of different orders being formed simultaneously whereas they have far lower energy than the M^{th}-order diffraction image. For instance, when a diffractive optical element 10 designed for concentrating energy into the first order diffraction is used, i.e. M=1, an energy concentrated 1^{st}-order diffraction image 50 will be formed after the first beam L1 being diffracted by the diffractive optical element 10. Thereafter, by combining the aforesaid M^{th}-order diffraction image with another energy-concentrated N^{th}-order diffraction image, such as N=0, a series of images can be formed. It is noted the zero order diffraction is resulting from a condition that there is no diffractive optical element 10 provided in the stereovision system 100 of the present disclosure. That is, after passing through the filter 30, the first beam L1 will be projected directly toward the lens 21 of the optical imaging device 20, without the diffraction of ant diffractive optical element 10, and then into the image sensor 22 for forming the zero order image. Accordingly, by comparing the disparity between corresponding points in the series of images, i.e. the 1^{st}-order diffraction image 50 and the zero order diffraction image, the distance between the object 40 and the diffractive optical element 10 can be obtained. In the other embodiments, it is possible to design two different diffractive optical elements using different parameters for concentrating energy at different orders of diffraction and thereby generating two different diffraction images accordingly, and then, similarly by comparing the disparity between corresponding points in the two diffraction images, the distance between the object 40 and the diffractive optical element 10 can be obtained. In another word, the 1^{st}-order diffraction image 50 that is formed in the stereovision system with the diffractive optical element and the zero order diffraction image that is formed without the diffractive optical element are used for acting exactly as the left-eye image and right-eye image similar to human binocular vision, which is also true for the two different diffraction images resulting from the use of two diffractive optical elements using different parameters for concentrating energy at different orders of diffraction. It is noted that the stereovision system of the present disclosure is not restricted by having to specifically design its diffractive optical element 10 for concentrating energy to any specific order of diffraction, i.e. the M^{th}-order of diffraction as well as the N^{th}-order of diffraction can be any two different orders of diffraction according to actual requirement. Please refer to FIG. 8, which shows the relation between offset and target distance in the stereovision system of the present disclosure. As shown in FIG. 8, when the image offset is 125 pixels, the obtained distance is 5 cm; and when the image offset is 150 pixels, the obtained distance is 14 cm.

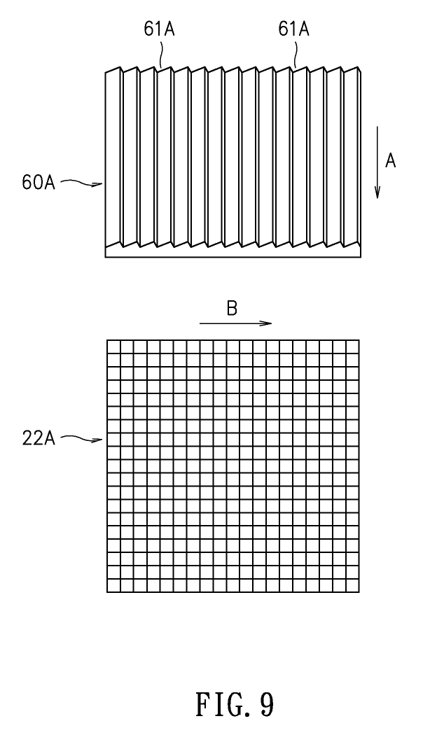

It is noted that the stereovision system of the present disclosure can use any type of diffractive optical element, only if it is capable of concentrating energy into its required order of diffraction. However, in order to prevent the images of multiple orders of diffraction to overlap with one another and thus cause difficulties to the posterior image analysis, the transmission of the diffractive optical element relating to the specified order of diffraction should be higher than 0.5. Please refer to FIG. 9, which is a schematic diagram showing how a blazed grating and an image sensing array are orientated with respect to each other in the stereovision system of the present disclosure. The blazed grating 60A shown in FIG. 9, being a grating having cross section similar to the blazed grating 60 shown in FIG. 3, is formed as a ruled grating comprising a plurality of strip-like grooves 61A arranged parallel to a first direction A. Moreover, the optical imaging device 22A paired with the blazed grating 60A is featured by a pixel orientation direction B and the pixel orientation direction B, being the scan line direction of the optical imaging device 22A, is disposed perpendicular to the first direction A. In this embodiment, the first direction A is vertically oriented while the pixel orientation direction B is horizontally oriented, by that the M^{th}-order diffraction image and the N^{th}-order diffraction image are located on the same scan line.

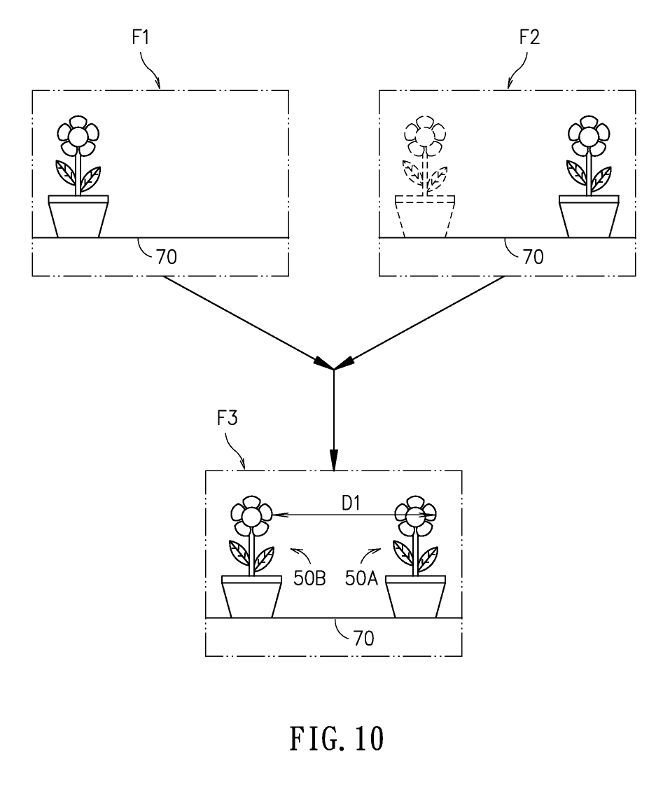

Please refer to FIG. 10, which is a schematic diagram showing how diffraction images resulting from the used of system of FIG. 9 are used for constructing a 3D stereovision. In FIG. 10, the images defined by solid lines are those formed from energy-concentrated diffracted light while those defined by dotted lines are those formed from diffracted light of lower energy. Moreover, the first set of images F1 is obtained without the use of any diffractive optical element, that is, they are zero-order diffraction images as N=0, in which the solid flowerpot is an energy-concentrated real image. Nevertheless, the second set of images F2 is obtained with the use of an diffractive optical element, that is, when M=1 for example, the solid flowerpot at the right is an energy-concentrated 1^{st}-order diffraction image that is a virtual image while the dotted flowerpot at the left is a zero order diffraction image of lower energy which is a real image. By combining the first set of images F1 and the second set of images F2 into a series of images by superimposing the first set of images F1 on the second set of images F2, a third set of images F3 can be obtained. On the same scan line 70 in the third set of images F3, one energy-concentrated 1^{st}-order image 50A and one energy-concentrated zero order image 50B can be obtained, and thereby, by measuring the disparity D1 between corresponding points in the 1^{st}-order image 50A and the zero order image 50B, the distance between the real flowerpot and the diffractive optical element can be calculated and thus obtained. It is noted that although the stereovision system of the present disclosure is capable of performing well under common ambient lighting condition, there can be an active light source in the system to be used as an auxiliary light source for enhancing images of the object. Moreover, the active light source can be a visible light source or an invisible light source.

To sum up, the present disclosure provides a stereovision system and method for calculating distance between object and diffractive optical element used in the system, in that the system uses a diffractive optical element to change its light traveling direction while enabling energy to be concentrated into one specified order of diffraction, i.e. M^{th} order, so as to formed an energy-concentrated M^{th}-order diffraction image, and then the diffractive optical element is removed from the system so as to form a zero-order real image that is provided to be combined with the previous M^{th}-order diffraction image so as to formed a series of images capable of acting exactly as the left-eye image and right-eye image similar to human binocular vision. Moreover, it is possible to design two different diffractive optical elements using different parameters for concentrating energy at different orders of diffraction and thereby generating two different diffraction images accordingly, and then, similarly by comparing the disparity between corresponding points in the two diffraction images, the distance between the object and the diffractive optical element can be obtained. As the stereovision system of the present disclosure is able to perform well under common ambient lighting condition without requiring illumination from any active light source, it can be constructed smaller in size and with comparatively simpler framework.

The disclosure being thus described, it will be obvious that the same may be varied in many ways. Such variations are not to be regarded as a departure from the spirit and scope of the disclosure, and all such modifications as would be obvious to one skilled in the art are intended to be included within the scope of the following claims.

What is claimed is:

1. A stereovision system, comprising:
a diffractive optical element, provided for allowing a first beam containing information relating to an object to pass through and thus being transformed into a second beam containing information relating to the object; and
an optical imaging device, provided for receiving the second beam so as to concentrate the energy thereof for forming an M^{th}-order diffraction image;
wherein, a process is performed for combining the aforesaid M^{th}-order diffraction image with another energy-concentrated N^{th}-order diffraction image so as to form a series of images, and then, a calculation is performed basing upon the disparities between corresponding points in the series of images so as to obtain the distance between the object and the diffractive optical element.

2. The stereovision system of claim 1, wherein the aforesaid M and N represent different orders of diffraction.

3. The stereovision system of claim 1, wherein the N^{th}-order diffraction image is formed by the projection of the first beam directly onto the optical imaging device and thus being constructed in the optical imaging device.

4. The stereovision system of claim 1, wherein the transmission of the diffractive optical element relating to the M^{th}-order diffraction image is higher than 0.5.

5. The stereovision system of claim 1, wherein the diffractive optical element is a transmission blazed grating and the transmission blazed grating is a ruled grating composed of a plurality of strip-like grooves arranged parallel to a first direction.

6. The stereovision system of claim 5, wherein the optical imaging device is featured by a pixel orientation direction and the pixel orientation direction, being the scan line direction of the optical imaging device, is disposed perpendicular to the first direction.

7. The stereovision system of claim 6, wherein the M^{th}-order diffraction image and the N^{th}-order diffraction image are located on the same scan line.

8. The stereovision system of claim 6, wherein the first direction is vertically oriented while the pixel orientation direction is horizontally oriented.

9. The stereovision system of claim 1, wherein the first beam is a light selected from the group consisting of: an ambient light, a visible light and an invisible light.

10. The stereovision system of claim 1, further comprising:
a filter, disposed on the optical path of the first beam as it is projecting toward the diffractive optical element in a manner that the first beam is projected passing through the filter and thus traveling toward the diffractive optical element.

11. The stereovision system of claim 1, further comprising:
an active light source, capable of emitting visible light and invisible light, provided for enhancing images of the object.

12. The stereovision system of claim 1, further comprising:
an image sensor, for receiving the second beam and thus forming an image accordingly; and
a lens, disposed on the optical path of the second beam as it is projecting toward the image sensor in a manner that the second beam is projected passing through the lens and thus traveling toward the image sensor for forming the image therein.

13. A method for calculating distance between object and diffractive optical element, comprising the steps of:
enabling a first beam containing information relating to an object to pass through a diffractive optical element for transforming the same into a second beam containing information relating to the object;
projecting the second beam onto an optical imaging device for forming an energy-concentrated M^{th}-order diffraction image; and
combining the M^{th}-order diffraction image with another energy-concentrated N^{th}-order diffraction image so as to form a series of images, and then, basing upon the disparities between corresponding points in the series of images so as to obtain the distance between the object and the diffractive optical element.

14. The method of claim 13, wherein the aforesaid M and N represent different orders of diffraction.

15. The method of claim 13, wherein the N^{th}-order diffraction image is formed by the projection of the first beam directly onto the optical imaging device and thus being constructed in the optical imaging device.

16. The method of claim 13, wherein the series of images is formed by superimposing the M^{th}-order diffraction image on the N^{th}-order diffraction image.

17. The method of claim 13, wherein the transmission of the diffractive optical element relating to the M^{th}-order diffraction image is higher than 0.5.

18. The method of claim 13, wherein the diffractive optical element is a transmission blazed grating and the transmission blazed grating is a ruled grating composed of a plurality of strip-like grooves arranged parallel to a first direction.

19. The method of claim 18, wherein the optical imaging device is featured by a pixel orientation direction and the pixel orientation direction, being the scan line direction of the optical imaging device, is disposed perpendicular to the first direction.

20. The method of claim 19, wherein the M^{th}-order diffraction image and the N^{th}-order diffraction image are located on the same scan line.

21. The method of claim 19, wherein the first direction is vertically oriented while the pixel orientation direction is horizontally oriented.

22. The method of claim 13, wherein the first beam is a light selected from the group consisting of: an ambient light, a visible light and an invisible light.

23. The method of claim 13, further comprising a step of:
providing a filter while disposing the same on the optical path of the first beam as it is projecting toward the diffractive optical element in a manner that the first beam is projected passing through the filter and thus traveling toward the diffractive optical element.

24. The method of claim 13, further comprising a step of:
providing an active light source capable of emitting visible light and invisible light for enhancing images of the object.

25. The method of claim 13, wherein the optical imaging device further comprises:
an image sensor, for receiving the second beam and thus forming an image accordingly; and
a lens, disposed on the optical path of the second beam as it is projecting toward the image sensor in a manner that the second beam is projected passing through the lens and thus traveling toward the image sensor for forming the image therein.
